(19) United States
(12) Patent Application Publication
(10) Pub. No.: US 2025/0125536 A1
(43) Pub. Date: Apr. 17, 2025

(54) ANTENNA, ELECTRONIC DEVICE AND METHOD OF FABRICATING ANTENNA

(71) Applicant: Chengdu Tianma Micro-Electronics Co.,Ltd., Chengdu (CN)

(72) Inventors: Min MING, Chengdu (CN); Yifan XING, Chengdu (CN); Jing HUANG, Chengdu (CN); Lei GONG, Chengdu (CN); Yingru HU, Chengdu (CN)

(21) Appl. No.: 18/600,795

(22) Filed: Mar. 11, 2024

(30) Foreign Application Priority Data
Oct. 11, 2023 (CN) 202311316420.6

(51) Int. Cl. H01Q 21/06; H01Q 3/30

(52) U.S. Cl. CPC H01Q 21/061; H01Q 3/30

(57) ABSTRACT

An antenna, an electronic device, and a method for forming an antenna are provided. The antenna includes a first substrate, a phased array antenna layer located on one side of the first substrate, a conductive layer located on a side of the phased array antenna layer facing away from the first substrate and including a plurality of conductive electrodes; a first liquid crystal layer located on a side of the conductive layer facing away from the phased array antenna layer, and a first antenna layer located on a side of the first liquid crystal layer away from the phased array antenna layer and including a plurality of first radiators.

### CROSS-REFERENCE TO RELATED APPLICATION

This application claims the priority of Chinese Patent Application No. 202311316420.6, filed on Oct. 11, 2023, the content of which is incorporated by reference in its entirety.

### TECHNICAL FIELD

The present disclosure generally relates to the field of antenna technologies and, more particularly, relates to an antenna, an electronic device, and a method of fabricating an antenna.

### BACKGROUND

With the rapid growth of communication network capacity, ubiquitous wireless connections become a reality. However, highly complex networks, high-cost hardware, and increasing energy consumption will become key issues faced by wireless communications in the future. Reconfigurable intelligent surface (RIS) antennas stand out for their unique features of low cost, low energy consumption, programmability, and easy deployment. Deploying RIS antennas on the surfaces of various objects in the wireless transmission environment is expected to break through the uncontrollability of traditional wireless channels, build an intelligent programmable wireless environment, and introduce new ways of wireless communication in the future. On the one hand, RIS antennas can actively enrich channel scattering conditions and enhance the multiplexing gain of wireless communication systems; on the other hand, RIS antennas can realize signal propagation direction control and in-phase superposition in three-dimensional space, increase received signal strength, and improve transmission performance between communication devices.

The RIS antenna is an artificial electromagnetic surface structure with programmable electromagnetic properties, developed from metamaterial technology. Traditional metamaterials can realize strange physical phenomena such as electromagnetic black holes and electromagnetic invisibility cloaks, but they are described by equivalent medium parameters and appear as single-function and solidified simulated metamaterials. The current solution is to install fixed devices or unchangeable material coatings, or patches, etc. on the surface of the antenna, which cannot flexibly and effectively adjust the radiation phase. The present disclosed antennas, electronic devices and methods of fabricating antennas are direct to solve one or more problems set forth above and other problems in the arts.

### SUMMARY

One aspect of the present disclosure provides an antenna. The antenna includes a first substrate; a phased array antenna layer located on one side of the first substrate; a conductive layer located on a side of the phased array antenna layer facing away from the first substrate and including a plurality of conductive electrodes; a first liquid crystal layer located on a side of the conductive layer facing away from the phased array antenna layer; and a first antenna layer located on a side of the first liquid crystal layer away from the phased array antenna layer and including a plurality of first radiators.

Another aspect of the present disclosure provides an electronic device. The electronic device includes an antenna. The antenna includes a first substrate; a phased array antenna layer located on one side of the first substrate; a conductive layer located on a side of the phased array antenna layer facing away from the first substrate and including a plurality of conductive electrodes; a first liquid crystal layer located on a side of the conductive layer facing away from the phased array antenna layer; and a first antenna layer located on a side of the first liquid crystal layer away from the phased array antenna layer and including a plurality of first radiators.

Another aspect of the present disclosure provides a method for forming an antenna. The method includes providing a first substrate and a second substrate; forming a phased array antenna layer between the first substrate and the second substrate and forming a conductive layer including a plurality of conductive electrodes on a side of the second substrate away from the first substrate; providing a third substrate; forming a first antenna layer including a plurality of first radiators on one side of the third substrate; and aligning and bonding the second substrate and the third substrate such that the first antenna layer is located on the side of the third substrate facing the conductive layer, and the first projection of the first radiator on the first substrate and the second projection of the conductive electrode on the first substrate are at least partially overlapped and a first liquid crystal layer is formed between the second substrate and the third substrate.

Other aspects of the present disclosure can be understood by those skilled in the art in light of the description, the claims, and the drawings of the present disclosure.

### BRIEF DESCRIPTION OF THE DRAWINGS

To illustrate the technical solutions in the embodiments of the present disclosure more clearly, the following briefly introduces the accompanying drawings used in the description of the embodiments. Obviously, the accompanying drawings in the following description are only some embodiments of the present disclosure, for those of ordinary skill in the art, other drawings can also be obtained from these drawings without creative effort.

FIG. 1 illustrates an exemplary antenna according to various disclosed embodiments of the present disclosure;

FIG. 2 illustrates a partial cross-sectional view of an exemplary antenna according to various disclosed embodiments of the present disclosure;

FIG. 3 illustrates a partial cross-sectional view of another exemplary antenna according to various disclosed embodiments of the present disclosure;

FIG. 4 illustrates a partial view of a signal propagation direction of an exemplary antenna according to various disclosed embodiments of the present disclosure;

FIG. 5 illustrates a flowchart of an exemplary fabrication method of an antenna according to various disclosed embodiments of the present disclosure;

FIGS. 6-14 illustrate structures corresponding to certain steps of an exemplary fabrication method of an antenna according to various disclosed embodiments of the present disclosure;

FIG. 15 illustrates a partial cross-sectional view of another exemplary antenna according to various disclosed embodiments of the present disclosure;

FIG. 16 illustrates a partial cross-sectional view of another exemplary antenna according to various disclosed embodiments of the present disclosure;

FIG. 17 illustrates a structure after forming a first phase-shifting electrode layer on a second substrate of an exemplary antenna according to various disclosed embodiments of the present disclosure;

FIG. 18 illustrates a partial cross-sectional view of another exemplary antenna according to various disclosed embodiments of the present disclosure;

FIG. 19 illustrates a partial cross-sectional view of another exemplary antenna according to various disclosed embodiments of the present disclosure; and

FIG. 20 illustrates an exemplary electronic device according to various disclosed embodiments of the present disclosure.

### DETAILED DESCRIPTION

Exemplary embodiments will now be described more fully with reference to the accompanying drawings. However, exemplary embodiments may be embodied in various forms and should not be construed as limited to the embodiments set forth herein; rather, these embodiments are provided such that this disclosure will be thorough and complete, and will fully convey the concepts of example embodiments to persons skilled in the art. The same reference numerals in the drawings represent the same or similar structures, and thus their repeated description will be omitted. The words “or” and “otherwise” in the description may mean “and” or “or”. Although the terms, “upper”, “lower”, or “between”, etc., may be used in this specification to describe various illustrative features and elements of the present disclosure, these terms are used herein for convenience only, for example, according to the direction of the drawings illustrated in the drawings. Nothing in this specification should be construed as requiring a specific three-dimensional orientation of a structure to fall within the scope of this disclosure. Although “first” or “second” are used in this specification to represent certain features, they are only for expression purposes and are not intended to limit the number and importance of specific features.

The structure of the antenna in various embodiments will be described in detail below with reference to the accompanying drawings. It should be understood that the drawings and the following description are only examples and are not intended to limit the scope of protection of the present application.

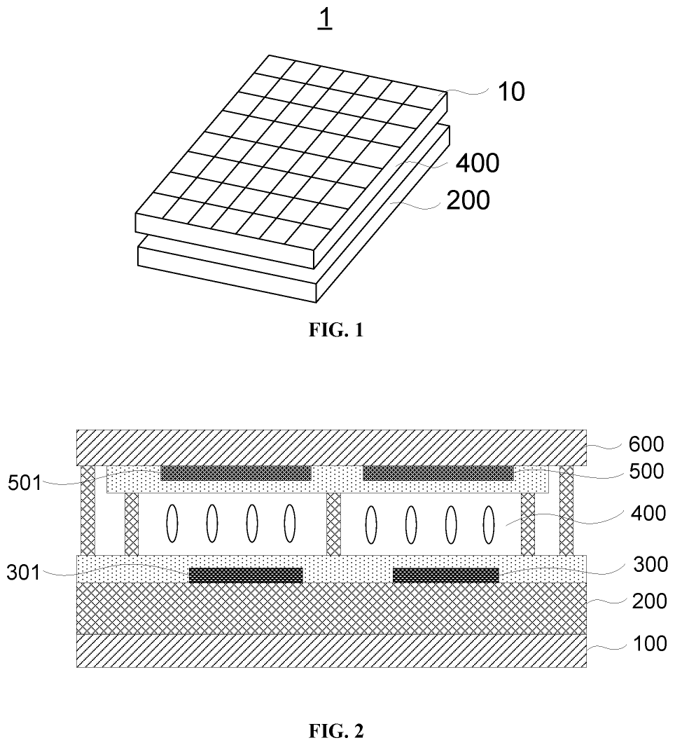

The present disclosure provides an antenna, an electronic device and a method for forming an antenna. FIG. 1 illustrates an exemplary antenna according to various disclosed embodiments of the present disclosure. FIG. 2 illustrates a partial cross-sectional view of the exemplary antenna.

As shown in FIG. 1, the antenna 1 may include a plurality of antenna units 10 arranged as an array. As shown in FIG. 2, the antenna 1 may include a first substrate 100, a phased array antenna layer 200 located on one side of the first substrate 100, a conductive layer 300 located on the side of the phased array antenna layer 200 facing away from the first substrate 100 and including a plurality of conductive electrodes 301, a first liquid crystal layer 400 located on the side of the conductive layer 300 facing away from the phased array antenna layer 200, a first antenna layer 500 located on the side of the first liquid crystal layer 400 facing away from the phased array antenna layer 200 and including a plurality of first radiators 501; and a third substrate 600. In one embodiment, the third substrate 600 may be a rigid substrate, for example, a glass substrate.

In one embodiment, the first liquid crystal layer 400 may be formed on one side of the phased array antenna layer 200 of the antenna. When using the antenna, the frequency and/or phase parameters of the transmitted signal may be adjusted by reasonably arranging the liquid crystal deflection angles of each liquid crystal material of the first liquid crystal layer 400, the spatial electromagnetic waves may be further actively and intelligently controlled through programming to form an electromagnetic field with controllable parameters such as amplitude, phase, polarization or frequency. Therefore, through the cooperation between the first liquid crystal layer 400 and the phased array antenna layer 200, a more flexible antenna function adjustment method may be achieved.

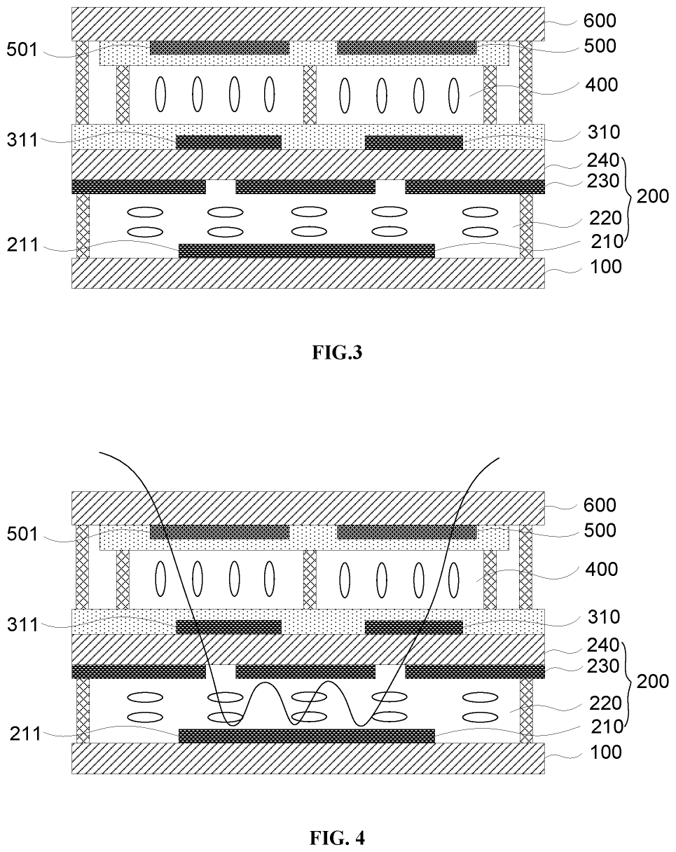

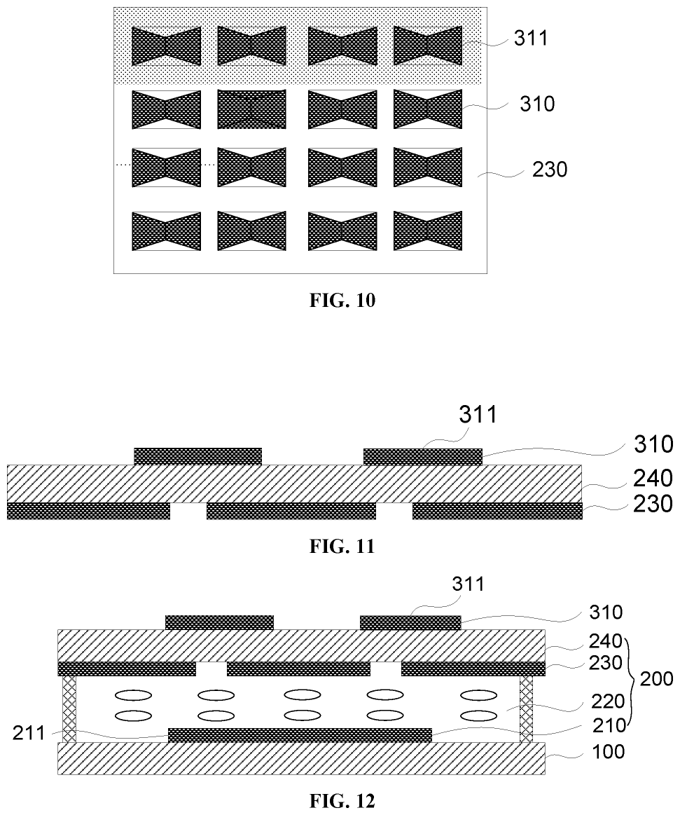

FIG. 3 shows a partial cross-sectional view of an exemplary antenna according to an embodiment of the present disclosure. In one embodiment, the first substrate 100 may be a rigid substrate (such as a glass substrate), a high-frequency circuit board, a silicon wafer, or other substrate. The conductive layer 300 may be the second antenna layer 310, and the conductive electrode 301 may be the second radiator 311. The second radiator 311 in the second antenna layer 310 may adopt a block structure, such as the comb-shaped structure illustrated in FIG. 10 (wide at both ends and narrow in the middle). The comb-shaped structure may have the effect of enhancing the radiation efficiency and optimizing and compensating the electrical field distribution. However, the second radiator 311 may also be a rectangular block or other shapes.

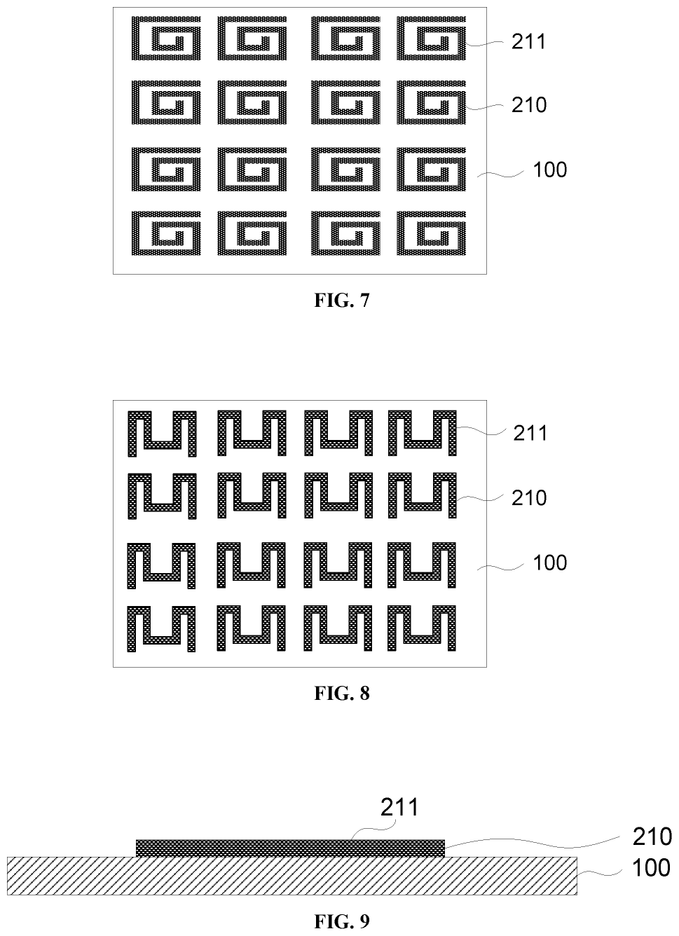

The phased array antenna layer 200 may include second phase-shifting electrode layer 210 located on one side of the first substrate 100 and including a plurality of second phase-shifting electrodes 211. The second phase-shifting electrodes 211 may adopt a linear structure, such as the square shape illustrated in FIG. 6, may also be a zigzag structure as shown in FIG. 7, or may be a serpentine structure as shown in FIG. 8, etc.

The phased array antenna layer 200 may also include the second liquid crystal layer 220 located on the side of the second phase-shifting electrode layer 210 facing away from the first substrate 100 and a second substrate 240 located on the side of the second liquid crystal layer 220 facing away from the first substrate 100. In one embodiment, the second substrate 240 may be a rigid substrate, such as a glass substrate, etc.

Further, the phased array antenna layer 200 may include a ground electrode layer 230 located on the side of the second substrate 240 facing the first substrate 100 and provided with a plurality of slits.

In this embodiment, the first projection of the first radiator 501 on the first substrate 100 and the second projection of the second radiator 311 on the first substrate 100 may be at least partially overlapped such that the signal may be transmitted smoothly between the first radiator 501 and the second radiator 311. The second projection of the second radiator 311 on the first substrate 100 may be in contact with the second phase-shifting electrode 211. The second projection of the second radiator 311 on the first substrate 100 and the third projection of the second phase-shifting electrode 211 on the first substrate 100 may be at least partially overlapped such that signals may be smoothly transmitted between the second radiator 311 and the second phase-shifting electrode 211. The second projection of the second radiator 311 on the first substrate 100 and the fourth projection of the slits of the ground electrode layer 230 on the first substrate 100 may be at least partially overlapped. The third projection of the second phase-shifting electrode 211 on the first substrate 100 and the fourth projection of the slits of the ground electrode layer 230 on the first substrate 100 may be at least partially overlapped such that the signal may be smoothly transmitted between the second radiator 311 and the second phase-shifting electrode 211 through the slits of the ground electrode layer 230.

The direction of the signal propagation in the antenna is schematically shown in FIG. 4. First, the signal may enter inside of the antenna from the first radiator 501 on the right and may be transmitted to the second radiator 311 through the first liquid crystal layer 400, and then may enter the second liquid layer 220 by passing through the right slit of the ground electrode layer 230 from the second radiator 311. Then, the signal may be further transmitted to the second phase-shifting electrode 211, reflected at the second phase-shifting electrode 211, pass through the second liquid crystal layer 220 again, pass through the left slit of the ground electrode layer 230 and may reach the second radiator 311. Then, the signal may pass through the first liquid crystal layer 400 again and may be emitted outward through the first radiator 501. The first liquid crystal layer 400 may be a variable dielectric layer. By adjusting the change of the deflection voltage applied on the first liquid crystal layer 400, the deflection angle of the liquid crystal molecules in the first liquid crystal layer 400 may be adjusted, thereby changing the dielectric constant of the first liquid crystal layer 400. During the signal propagation, by adjusting the voltage applied to the first liquid crystal layer 400 according to the required frequency, the dielectric constant of the first liquid crystal layer 400 may be adjusted, thereby adjusting the signal transmission frequency. Further, by adjusting the voltage applied to the second liquid crystal layer 220, the deflection of the liquid crystal molecules in the second liquid crystal layer 220 may be adjusted, thereby adjusting the signal phase and achieving frequency modulation and phase modulation of the transmitted signal. Therefore, in one embodiment, the first liquid crystal layer 400 may mainly play the role of frequency modulation and relay, while the second liquid crystal layer 220 may mainly play the role of phase adjustment and beam scanning.

In one embodiment, the second antenna layer 310 may also be multiplexed as a driving electrode layer of the first liquid crystal cell, and the first antenna layer 500 may also be multiplexed as a ground electrode layer of the first liquid crystal cell. The antenna may also include a third driver IC and a fourth driver IC (not shown in the figure). The third driving IC may be connected to the first radiator 501 and the second radiator 311. The third driving IC may be configured to form a third driving voltage difference between the second radiator 301 and the first radiator 501 according to a third mapping curve (the third driving voltage may be applied to the second radiator 311, and a com ground signal may be applied to the first radiator). The third mapping curve may be a mapping curve between the target frequency and the third driving voltage difference. The fourth driving IC may be connected to the second phase-shifting electrode 211 and the ground electrode layer 230 (the fourth driving voltage may be applied to the second phase-shifting electrode 211, and the com ground signal is applied to the ground electrode layer 230). The fourth driving IC may be used to form a fourth driving voltage difference between the second phase-shifting electrode 211 and the ground electrode layer 230 according to a fourth mapping curve. The fourth mapping curve may be the mapping of the target phase and the fourth driving voltage difference.

Therefore, during the operation of the antenna, by adjusting the value of the third driving voltage difference, the frequency of the signal after passing through the first liquid crystal layer 400 may be adjusted to achieve a signal frequency modulation. By adjusting the difference of the value of the fourth driving voltage, the phase of the signal after passing through the second liquid crystal layer 220 may be adjusted, which may realize the effect of adjusting the phase, thereby providing a more flexible signal adjustment method, adapting to more different usage scenarios, and realizing the intelligence adjust of the signal. The second substrate 240 may be a glass substrate with a relatively large dielectric constant. The upper and lower electrode layers of the second substrate 240 may not affect each other, thus achieving independent control of the two liquid crystal layers.

In one embodiment, the partial cross-sectional view shown in FIG. 3 corresponding to one antenna unit is used as an example, each antenna unit may include one second phase-shifting electrode 211, two second radiators 311 (one for relay when receiving signals, and one for relay when transmitting signals) and two first radiators 501 (one for signal reception and one for signal transmission). Each antenna unit may be configured with a third driver IC and a fourth driver IC respectively. In other embodiment, the antenna may be configured with an integral third driver IC and an integral fourth driver IC, but the third driver IC may include multiple voltage outputs to control each antenna unit respectively, and the fourth driving IC may include multiple voltage outputs to control each antenna unit respectively. In another embodiment, each of the antenna units may include one of the second phase-shifting electrodes 211, one of the second radiators 311 and one of the first radiators 501. Accordingly, the signal may pass through the same layer during entering the antenna unit and emitting out the antenna, but the direction of the transmission may be opposite. In another embodiment, the number of first radiators 501, second radiators 311 and second phase-shifting electrodes 211 in the antenna unit may be greater, which all fall within the protection scope of this disclosure.

In one embodiment, the first radiators 501 in the first antenna layer 500 may all have the same size. Since the first radiators 501 of the same size may limit the frequency range adjusted by the first liquid crystal layer 400 to a certain extent, to further expand the applicable frequency range of the antenna, the first antenna layer 500 may include the first radiators 501 of at least two types of areas, and the spacing between adjacent first radiators 501 in the first antenna layer 500 may include at least two dimensions. Therefore, the first antenna layer 500 may realize signal transmission in multiple frequency ranges, further broadening the applicable antenna range of the antenna, and increasing the bandwidth of the antenna. In one embodiment, the first antenna layer 500 may include at least two types of antenna areas, each of the antenna areas may include a plurality of first radiators 501, and the first radiator area and the first radiator spacing of each of the antenna areas may be different from other types of antenna areas. In the first antenna layer 500, in the clockwise direction, according to the arrangement order of the antenna areas, the area of the first radiator 501 may gradually increase or decrease. In the first antenna layer 500, in the clockwise direction, according to the arrangement order of the antenna areas, the spacing between adjacent first radiators 501 in the antenna area may gradually increase or decrease, for example, the distance between adjacent first radiators 501 corresponding to the first radiators 501 of the larger area may be also larger, and the distance between adjacent first radiators 501 corresponding to the first radiators 501 of the smaller area may also be smaller.

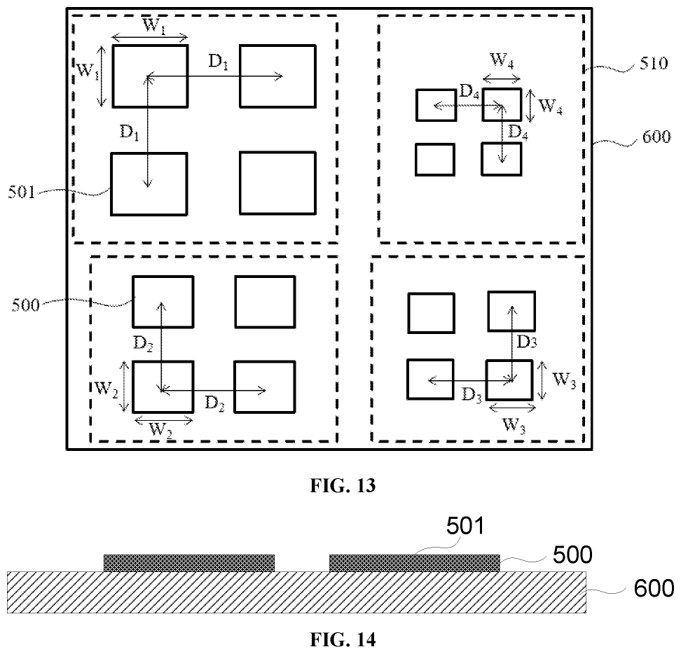

The arrangement of the first radiators 501 of the four antenna areas 510 is exemplarily shown in FIG. 13. The four first radiators 501 in each dotted box may form an antenna area 510. From the perspective of FIG. 13, in the clockwise direction, according to the arrangement order of the antenna areas 510, the area of the first radiators 501 may gradually increase, and the spacing between the first radiators 501 may gradually increase. Such a configuration may have the best broadband broadening effect. In the example of FIG. 13, the frequency modulation control of four frequency ranges may be achieved. For example, the antenna area 510 in the upper left corner may achieve a frequency modulation range of 18 GHz-21 GHz. The area of the corresponding first radiator 501 may be w1×w1, and the distance between two adjacent first radiators 501 may be D1. The antenna area 510 in the bottom left corner may achieve a frequency modulation range of 16 GHz-19 GHz. The area of the corresponding first radiator 501 may be w2×w2. The distance between two adjacent first radiators 501 may be D2. The antenna area 510 in the lower right corner may achieve a frequency modulation range of 14 GHz-17 GHz. The corresponding area of the first radiator 501 may be w3×w3. The distance between two adjacent first radiators 501 may be D3. The antenna area 510 in the upper right corner may achieve a frequency modulation range of 12 GHz-17 GHz. The corresponding area of the first radiator 501 may be w4×w4, and the spacing between two adjacent first radiators 501 may be D4. Accordingly, the first antenna layer 500 including the four types of antenna areas 510 may cooperate with the first liquid crystal layer 400 to achieve a frequency modulation range of 12 GHz-21 GHz. w1>w2>w3>w4, and D1>D2>D3>D4. FIG. 13 only illustrates one example. In different implementations, the arrangement of the antenna areas 510, the number of first radiators 501 in each antenna area, the number of antenna areas, and the frequency modulation range corresponding to the first radiators 501 in each antenna area 510 may be adjusted, and they may all fall within the protection scope of this disclosure.

FIG. 13 takes the structure of the first antenna layer 500 as an example to illustrate the signal frequency modulation method when there are multiple antenna areas. When the antenna receives an 18 GHz signal, the third driving IC may adjust the deflection of the liquid crystal molecules in the first liquid crystal layer 400 of each antenna area 510. After the liquid crystal molecules in the antenna areas corresponding to the upper left corner and the lower left corner are deflected, the signal may be further transmitted to the second antenna layer 310. If the 18 GHz signal transmission function is still unable to be achieved after the liquid crystal molecules corresponding to the antenna areas in the upper right corner and lower right corner are deflected, the corresponding antenna units may not need to work. When receiving a 15 GHz signal, the antenna units corresponding to the antenna areas in the upper right corner and lower right corner may still work normally. However, after the liquid crystal molecules in the antenna areas in the upper left corner and lower left corner are deflected, the 15 GHz signal transmission function may still be unable to be achieved, then the corresponding antenna unit may not work. Such a configuration may be applicable to a larger signal frequency range than a structure using first radiators of a same size.

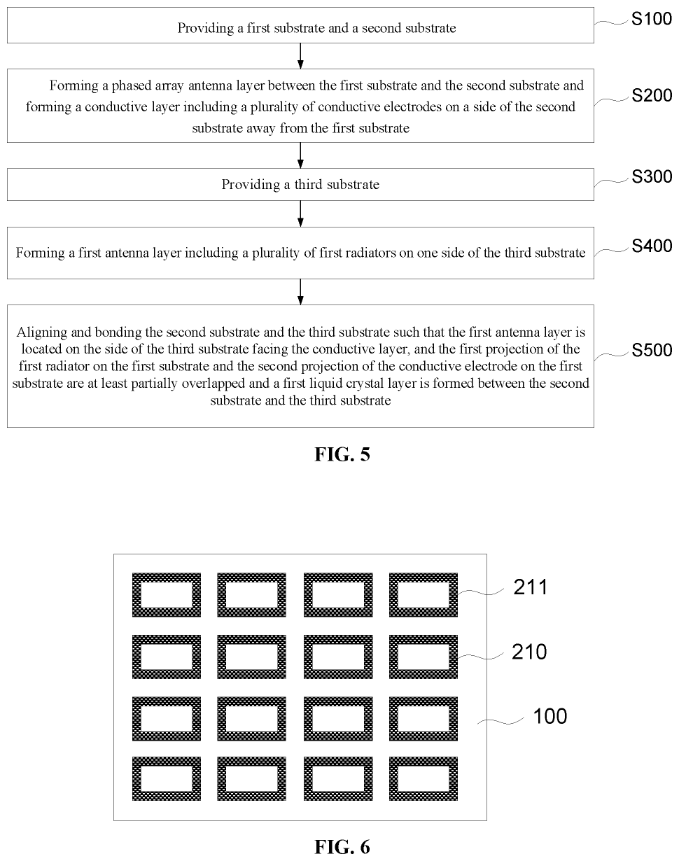

The present disclosure also provides a method for forming an antenna. FIG. 5 illustrates the flowchart of an exemplary method for forming an antenna according to various disclosed embodiments of the present disclosure.

As shown in FIG. 5, the method may include:
S100: providing a first substrate and a second substrate;
S200: forming a phased array antenna layer between the first substrate and the second substrate and forming a conductive layer including a plurality of conductive electrodes on a side of the second substrate away from the first substrate;
S300: providing a third substrate;
S400: forming a first antenna layer including a plurality of first radiators on one side of the third substrate; and
S500: aligning and bonding the second substrate and the third substrate such that the first antenna layer may be located on the side of the third substrate facing the conductive layer, the first projection of the first radiator on the first substrate and the second projection of the conductive electrode on the first substrate may be at least partially overlapped, and a first liquid crystal layer may be formed between the second substrate and the third substrate.

In one embodiment, the step S200 of forming a phased array antenna layer between the first substrate and the second substrate and forming a conductive layer on the side of the second substrate facing away from the first substrate may include:
forming a second phase-shifting electrode layer on one side of the first substrate;
forming a ground electrode layer with a plurality of slits on the first side of the second substrate and forming the conductive layer on the second side of the second substrate; and
aligning the first substrate and the second substrate such that the ground electrode layer is located on the side of the second substrate facing the second phase-shifting electrode layer, and the fourth projection of the slits of the ground electrode layer on the first substrate and the third projection of the second phase-shifting electrode layer on the first substrate may be at least partially overlapped, and a second liquid crystal layer may be formed between the first substrate and the second substrate.

The exemplary forming process of the antenna will be introduced in detail below with reference to FIGS. 6-14.

As shown in FIGS. 6-7, a first substrate 100 may be first provided, and a second phase-shifting electrode layer 210 may be formed on one side of the first substrate 100. In one embodiment, a magnetron sputtering process, an electroplating process, or a chemical plating process, etc., may be used to form a metal film on a glass substrate, a high-frequency circuit board or a silicon wafer. The material of the metal film may include Cu, Au, Ag, or their low-resistance alloy, etc. The thickness of the metal film may be in a range of approximately 2000 nm-3000 nm, and may be patterned to form the second phase-shifting electrode layer 210. The second phase-shifting electrode 211 in the second phase-shifting electrode layer 210 may adopt a linear structure as shown in FIG. 6, FIG. 7 or FIG. 8, and may not be limited thereto.

As shown in FIGS. 10-11, a second substrate 240 may be provided, a ground electrode layer 230 may be formed on the first side of the second substrate 240, and the second antenna layer 310 may be formed on the second side of the second substrate 240. The ground electrode layer 230 may be provided with a plurality of slits. The forming process may include forming metal films on the upper and lower sides of the glass substrate, the high-frequency circuit board or the silicon wafer through a magnetron sputtering process, an electroplating process, a chemical plating process, or other processes. The material of the metal films may include Cu, Au, or Ag, etc. The thickness of the metal films may be in a range of approximately 2000 nm-3000 nm, and may be patterned to form the second antenna layer 310 and the ground electrode layer 230 on the upper and lower sides respectively. In one embodiment, the process for forming the metal films may be achieved by an electrochemical plating process to achieve the double-sided film formation. Then, a double-sided exposure and etching may be performed on both sides of the second substrate 240 to achieve patterning of the upper and lower layers. The second radiator 311 in the second antenna layer 310 may adopt a block structure.

As shown in FIG. 12, the first substrate 100 and the second substrate 240 may be aligned and bonded such that the ground electrode layer 230 may be located on one side the second substrate 240 facing the second phase-shifting electrode layer 210. The fourth projection of the slits of the ground electrode layer 230 on the first substrate 100 and the third projection of the second phase-shifting electrode 211 on the first substrate 100 may be at least partially overlapped, and the second liquid crystal layer 220 may be formed between the first substrate 100 and the second substrate 240. The second liquid crystal layer 220 may be formed using a liquid crystal cell formation method, and may include an alignment film, liquid crystal molecule supporting materials, and frame sealing glue, etc.

As shown in FIGS. 13-14, a third substrate 600 may be provided, and a first antenna layer 500 may be formed on one side of the third substrate 600. The corresponding process may include forming metal films on the upper and lower sides of the substrate formed by the glass substrate, a high-frequency circuit board and a silicon wafer through a magnetron sputtering process, an electroplating process, a chemical plating process, or other processes. The material of the metal films may include Cu, Au, or Ag, etc. The metal films may have a thickness in a range of approximately 2000 nm-3000 nm, and may be patterned to form the first antenna layer 500. The first radiators 501 in the first antenna layer 500 may adopt a block structure, such as the rectangular structure illustrated in FIG. 13 or other shapes.

Then, the second substrate 240 and the third substrate 600 may be aligned and bonded such that the first antenna layer 500 may be located on the side of the third substrate 600 facing the conductive layer. The first projection of the first radiator 501 on the first substrate 100 and the second projection of the conductive electrodes on the first substrate 100 may be at least partially overlapped, and the first liquid crystal layer 400 may be formed between the second substrate 240 and the third the substrates 600. Accordingly, the structure of the antenna shown in FIG. 3 may be completely formed. To form the first liquid crystal layer 400, the side of the second substrate 240 facing the third substrate 600 may be coated with a PI film using a non-contact method such as inkjet printing, and the PI film may be aligned using a non-contact method such as photo alignment. The remaining components, including liquid crystal molecules and support pillars, etc., may be formed using the existing method for forming the liquid crystal cells.

FIG. 15 is a partial cross-sectional view of another exemplary antenna according to one embodiment of the present disclosure. The difference between this embodiment and the previous embodiment may include that the first substrate 100 may be a first flexible substrate 700, the second substrate 240 may be a rigid substrate, and the third substrate 600 may be a second flexible substrate 800. The first substrate 100 and the third substrate 600 may be implemented using flexible films. The working principle of the antenna in this embodiment may be same as that in the previous embodiment, and will not be described again here.

The preparation method of the antenna in this embodiment may be basically same as that shown in FIG. 5. In the step S100, a first substrate 100 may be provided, including providing a first flexible substrate 700 formed on the first substrate. In the step S300, a third substrate 600 may be provided, including providing a second flexible substrate 800 formed on the second substrate 240. In the step S500, after forming the first liquid crystal layer 400 between the second substrate 240 and the third substrate 600, the first flexible substrate 700 may be peeled off from the first substrate 100, and the second flexible substrate 800 may be peeled off from the second substrate 240.

By using the first substrate 100 and the third substrate 600 as flexible film substrates, the antenna may be applied to electronic devices with curved surfaces such that the first substrate 100 and the third substrate 600 may be properly bent to better fit the curved surface of the electronic device. The second substrate 240 as a rigid substrate may provide a desired support for the overall antenna.

In some embodiments, only the first substrate 100 may be a flexible film substrate, and both the second substrate 240 and the third substrate 600 may be rigid substrates. In other embodiments, only the third substrate 600 may be a flexible film substrate, and both the first substrate 100 and the second substrate 240 may be rigid substrates.

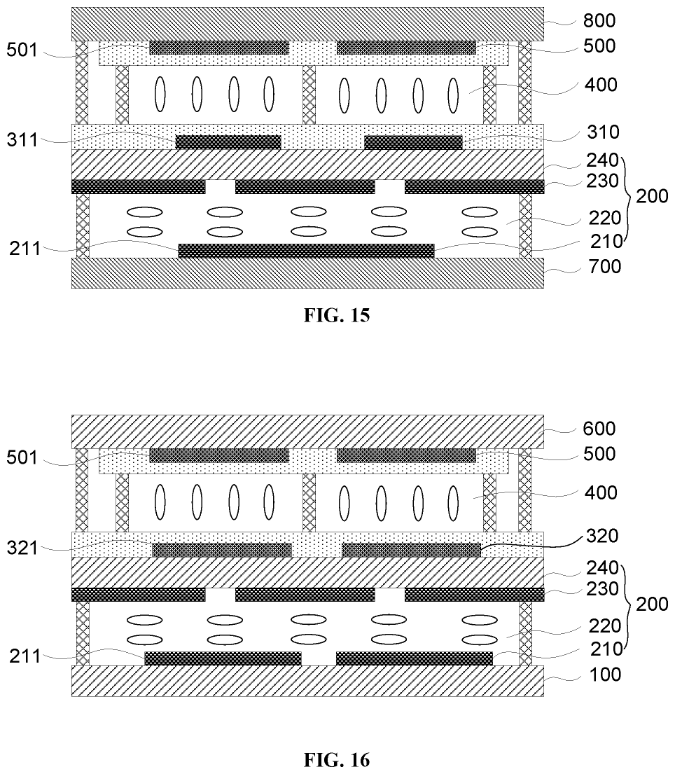

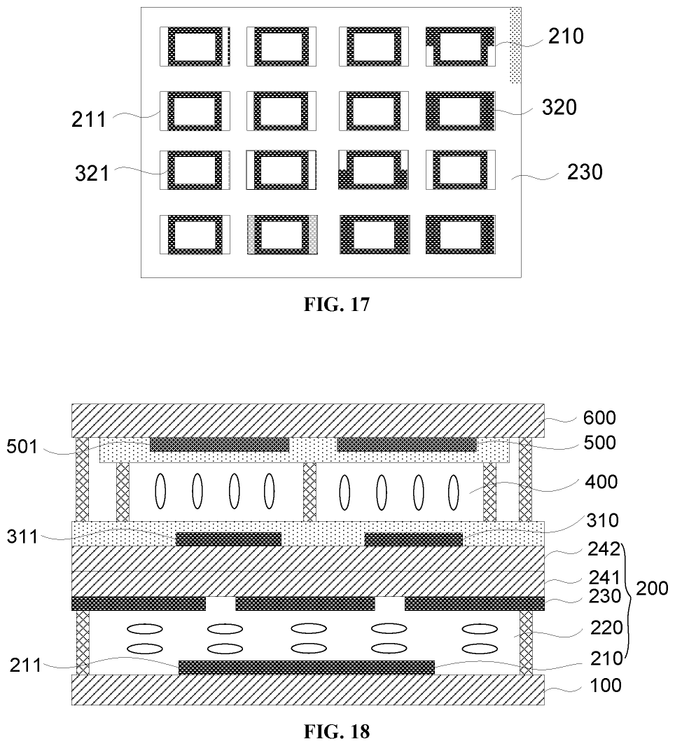

FIG. 16 is a partial cross-sectional view of another exemplary antenna according to various disclosed embodiments of the present disclosure. The difference between this embodiment and the previous embodiments may include that the conductive layer may be the first phase-shifting electrode layer 320 and the conductive electrode may be the first phase-shifting electrode 321. FIG. 17 is a top view of the first phase-shifting electrode layer 320 and the ground electrode layer 230 formed on the second substrate 240 of the antenna, in which the corresponding relationship between the first phase-shifting electrode 321 and the second phase-shifting electrode 211 are shown at the same time. The first phase-shifting electrode 321 may have a linear structure, such as a “ [symbol] ” structure as shown in FIG. 17, or a “ [symbol] ” structure like the second phase-shifting electrode 211 shown in FIG. 7, or a serpentine structure like the second phase-shifting electrode 211 shown in FIG. 8, etc.

In one embodiment, the first projection of the first radiator 501 on the first substrate 100 and the second projection of the first phase-shifting electrode 321 on the first substrate 100 may be at least partially overlapped such that the signal may be transmitted smoothly between the first radiator 501 and the first phase-shifting electrode 321. As shown in FIG. 17, the second projection of the first phase-shifting electrode 321 on the first substrate 100 may at least partially overlap with the third projection of the second phase-shifting electrode 211 on the first substrate 100, but may not be completely overlapped such that signals may be transmitted smoothly between the first phase-shifting electrode 321 and the second phase-shifting electrode 211 and the total length of the phase-shifting electrodes may be increased. The second projection of the first phase-shifting electrode 321 on the first substrate 100 may be at least partially overlapped with the fourth projection of the slit of the ground electrode layer 230 on the first substrate 100. The third projection of the second phase-shifting electrode 211 on the first substrate 100 and the fourth projection of the slit of the ground electrode layer 230 on the first substrate 100 may be at least partially overlapped such that the signal may pass the slits of the ground electrode layer 230 and smoothly transmit between the first phase-shifting electrode 321 and the second phase-shifting electrode 211.

In one embodiment, the first phase-shifting electrode 321 and the second phase-shifting electrode 211 may have the same width. However, the present disclosure is not limited to this. In other embodiments, the width of the first phase-shifting electrode 321 may also be larger or smaller than the width of the second phase-shifting electrode 211.

In one embodiment, both the first liquid crystal layer 400 and the second liquid crystal layer 220 may adjust the phase. The first phase-shifting electrode layer 320 may also be multiplexed as a driving electrode layer of the first liquid crystal cell, and the first antenna layer 500 may also be multiplexed as a ground electrode layer of the first liquid crystal cell. The antenna may also include a first driver IC and a second driver IC. The first driving IC may be connected to the first radiator 501 and the first phase-shifting electrode 321, and the first driving IC may be configured to form a first driving voltage difference between the first phase-shifting electrode 321 and the first radiator 501 (the first driving voltage may be applied to the first phase-shifting electrode 321, and the com ground signal may be applied to the first radiator 501) based on a first mapping curve. The first mapping curve may be the relationship between the first target phase and the first driving voltage difference. The second driving IC may be connected to the second phase-shifting electrode 211 and the ground electrode layer 230, and the second driving IC may be configured to form a second driving voltage difference between the second phase-shifting electrode 211 and the ground electrode layer 230 (the second driving voltage may be applied to the second phase-shifting electrode 211, and the com ground signal may be applied to the ground layer) based on a second mapping curve. The second mapping curve may be the mapping curve between the second target phase and the second driving voltage difference.

Therefore, during the operation of the antenna, by adjusting the value of the first driving voltage difference, the phase of the signal after passing through the first liquid crystal layer 400 may be adjusted to achieve a first-level signal phase modulation effect. The value of the difference between the two driving voltages may adjust the phase of the signal after passing through the second liquid crystal layer 220, and may achieve another level of signal phase modulation, thereby providing a double phase modulation effect, providing a more flexible signal adjustment method, and adapting to more different usage scenarios to realize intelligent adjustment of signals.

Through the structure of the antenna, the phase shift response speed may be improved, the thickness of the first liquid crystal layer 400 and the second liquid crystal layer 220 may be be reduced, and the liquid crystal response speed may be increased. The resolution based on target phase control may be improved, and the effective phase-shifting electrode length may be split into the lower second phase-shifting electrode 211 and the upper first phase-shifting electrode 321, thereby effectively reducing the size of each antenna unit. For an antenna of the same size, the structure adopting this disclosure may include more antenna units.

In one embodiment, each antenna unit may be configured with a first driver IC and a second driver IC. In another embodiment, an integral first driver IC and an integral second driver IC may be configured for the antenna, but the first driver IC may branch out multiple output voltages to control each antenna unit respectively, and the second driving IC may branch out multiple output voltages to control each antenna unit respectively. By setting the driving ICs of the first liquid crystal layer 400 and the second liquid crystal layer 220 independently, the bias driving accuracy may be improved, and the first mapping curve and the second mapping curve may adopt different control curves, and the two mapping curves may achieve the complementary effects of sensitivity.

FIG. 18 is a partial cross-sectional view of another exemplary antenna according to one embodiment of the present disclosure. The difference between this embodiment and the previous embodiments may include that the second substrate 240 may include a first sub-substrate 241 and a second sub-substrate 242. The ground electrode layer 230 may be formed on one side of the first sub-substrate 241, and a second antenna layer 310 may be formed on one side of the second sub-substrate 242. The structure may also be prepared by using the antenna preparation method shown in FIG. 4. For example, the step S200 of forming a phased array antenna layer between the first substrate and the second substrate, and forming a conductive layer on the side of the second substrate away from the first substrate may include:
forming a second phase-shifting electrode layer on one side of the first substrate;
forming a ground electrode layer including a plurality of slits on the first side of the first sub-substrate, and forming the second antenna layer on the first side of the second sub-substrate; and
aligning and bonding the second side of the first sub-substrate and the second side of the second sub-substrate.

The first substrate and the first sub-substrate may be aligned and bonded such that the ground electrode layer may be located on the side of the first sub-substrate facing the second phase-shifting electrode layer, the fourth projection of the slits on the first substrate and the third projection of the second phase-shifting electrode layer on the first substrate may be at least partially overlapped, and a second liquid crystal layer may be formed between the first substrate and the second substrate.

Using the antenna structure and preparation method of the present disclosure, when preparing the ground electrode layer and the second antenna layer, the metal layers may be formed on the two substrates respectively. Compared with forming metal layers with different patterns on both sides of the same substrate, lower requirements on the preparation process may need.

In some embodiments, the second substrate 240 may be replaced with the structures of the first sub-substrate 241 and the second sub-substrate 242, a first phase-shifting electrode layer may be formed on the first side of the second sub-substrate 242.

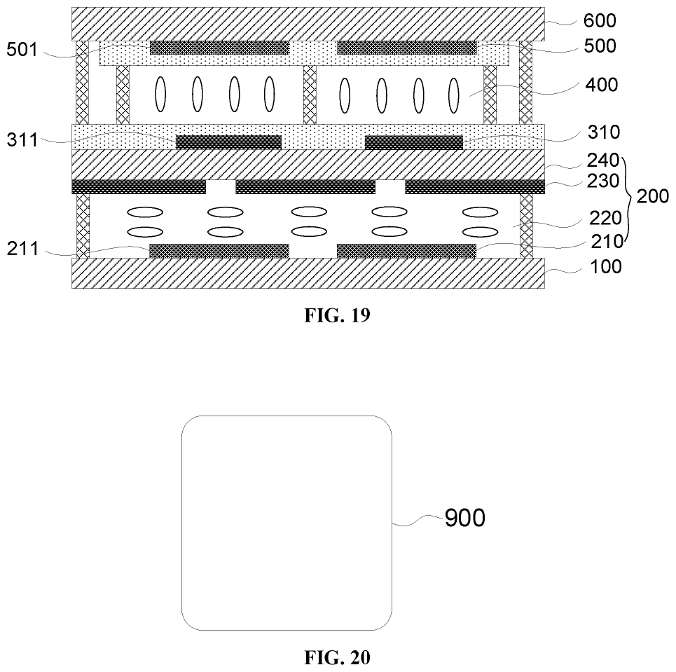

FIG. 19 is a partial cross-sectional view of another exemplary antenna according to one embodiment of the present disclosure. The difference between this embodiment and the previous embodiments may include that each antenna unit may include a second phase-shifting electrode 211, a second radiator 311 and a first radiator 501. FIG. 19 exemplarily shows a structure of two antenna units. In the use of this antenna, one first radiator 501 of each antenna unit may be used to receive signals and transmit signals at the same time. In an antenna of the same area, the antenna structure of this embodiment may further increase the number of antenna units provided.

The present disclosure also provides an electronic device. FIG. 20 illustrates an exemplary electronic device according to various disclosed embodiments of the present disclosure. As shown in FIG. 20, the electronic device 900 may include the antenna of any of the above embodiments. The electronic device may include a mobile phone, a wearable product, a computer, or a vehicle-mounted electronic device, etc., which is not specifically limited in this disclosure. The electronic device provided by the embodiments of the present disclosure may have the beneficial effects of the antenna provided by the embodiments of the present disclosure. The details may be referred to the specific descriptions of the antennas in the above embodiments, which will not be described again in this disclosure.

The above content is a further detailed description of the present disclosure in combination with specific preferred embodiments, and it cannot be concluded that the specific implementation of the present disclosure is limited to these descriptions. For those of ordinary skill in the technical field to which this disclosure belongs, several simple deductions or substitutions may be made without departing from the concept of this disclosure, which should be regarded as falling within the protection scope of this disclosure.

What is claimed is:

1. An antenna, comprising:
a first substrate;
a phased array antenna layer located on one side of the first substrate;
a conductive layer located on a side of the phased array antenna layer facing away from the first substrate and including a plurality of conductive electrodes;
a first liquid crystal layer located on a side of the conductive layer facing away from the phased array antenna layer; and
a first antenna layer located on a side of the first liquid crystal layer facing away from the phased array antenna layer and including a plurality of first radiators.

2. The antenna according to claim 1, wherein:
the conductive layer includes a first phase-shifting electrode layer and the conductive electrode includes a first phase-shifting electrode; or
the conductive layer includes a second antenna layer and the conductive electrode includes a second radiator.

3. The antenna according to claim 2, wherein:
the first phase shifting electrode is a linear structure; or
the second radiator is a block structure.

4. The antenna according to claim 1, wherein the phased array antenna layer comprises:
a second phase-shifting electrode layer located on one side of the first substrate and including a plurality of second phase-shifting electrodes;
a second liquid crystal layer located on a side of the second phase-shifting electrode layer facing away from the first substrate;
a second substrate located on a side of the second liquid crystal layer facing away from the first substrate; and
a ground electrode layer located on a side of the second substrate facing the first substrate and including a plurality of slits.

5. The antenna according to claim 4, wherein:
a first projection of a first radiator of the plurality of first radiators on the first substrate is at least partially overlapped with a second projection of a first conductive electrode of the plurality of first electrodes on the first substrate; and
a second projection of the conductive electrode on the substrate is at least partially overlapped with a third projection of a second phase-shifting electrode of the plurality of second phase-shifting electrodes on the first substrate.

6. The antenna according to claim 4, wherein:
a second projection of a conductive electrode of the plurality of conductive electrodes on the first substrate is at least partially overlapped with a fourth projection of a slit of the plurality of slits of the ground electrode layer on the first substrate; and
a third projection of a second phase-shifting electrode of the plurality of second phase-shifting electrodes on the first substrate is at least partially overlap with a fourth projection of the slit of the ground electrode layer on the first substrate.

7. The antenna according to claim 4, wherein:
the conductive layer includes the first phase-shifting electrode layer; and
the conductive electrode includes the first phase-shifting electrode.

8. The antenna according to claim 7, wherein:
a width of the first phase-shifting electrode is same as a width of the second phase-shifting electrode.

9. The antenna according to claim 7, further comprising:
a first driving IC connected to the first radiator and the first phase-shifting electrode and configured to form a first driving voltage difference between the first phase-shifting electrode and the first radiator based on a first mapping curve, wherein the first mapping curve is a mapping curve between a first target phase and the first driving voltage difference; and
a second driving IC connected to the second phase-shifting electrode and the ground electrode and configured to form a second driving voltage difference between the second phase-shifting electrode and the ground electrode based on a second mapping curve, wherein the second mapping curve is a mapping curve between a second target phase and the second driving voltage difference.

10. The antenna according to claim 4, wherein:
the conductive layer includes a second antenna layer; and
the conductive electrode includes a second radiator.

11. The antenna according to claim 10, further comprising:
a third driving IC connected to the first radiator and the second radiator and configured to form a third driving voltage difference between the second radiator and the first radiator based on a third mapping curve, wherein the third mapping curve is a mapping curve between a target frequency and the third driving voltage difference; and
a fourth driving IC connected to the second phase-shifting electrode and the ground electrode layer and configured to form a fourth driving voltage difference between the second phase-shifting electrode and the ground electrode layer based on a fourth mapping curve, wherein the fourth mapping curve is a mapping curve between a target phase and the fourth driving voltage difference.

12. The antenna according to claim 4, comprising:
a plurality of antenna units, wherein each of the plurality of antenna units includes one second phase-shifting electrode, two conductive electrodes and two first radiators, or each of the plurality of antenna units includes one second phase-shifting electrode, one conductive electrode and one first radiator.

13. The antenna according to claim 1, wherein:
the first antenna layer includes at least two areas of first radiators, and a spacing between two adjacent first radiators in the first antenna layer includes at least two sizes.

14. The antenna according to claim 1, wherein:
the first antenna layer includes at least two types of antenna areas;
each of the at least two antenna areas includes a plurality of first radiators;
an area of a first radiator of the plurality of first radiators and a spacing of the plurality of first radiators in each of the at least two antenna areas are different from those of other antenna areas; and
in the first antenna layer, in a clockwise direction, according to an arrangement order of the at least two antenna areas, the area of the first radiator gradually increases or decreases.

15. The antenna according to claim 14, wherein:
in the first antenna layer, in the clockwise direction, according to the arrangement order of the at least two antenna areas, the spacing of two adjacent first radiators of the plurality of radiators gradually increases or decreases.

16. The antenna according to claim 1, further comprising:
a third substrate located on a side of the first antenna layer facing away from the first liquid crystal layer, wherein the first substrate and/or the third substrate are flexible substrates.

17. An electronic device, comprising:
an antenna, including:
a first substrate;
a phased array antenna layer located on one side of the first substrate;
a conductive layer located on a side of the phased array antenna layer facing away from the first substrate and including a plurality of conductive electrodes;
a first liquid crystal layer located on a side of the conductive layer facing away from the phased array antenna layer; and
a first antenna layer located on a side of the first liquid crystal layer away from the phased array antenna layer and including a plurality of first radiators.

18. A method of for forming an antenna, comprising:
providing a first substrate and a second substrate;
forming a phased array antenna layer between the first substrate and the second substrate and forming a conductive layer including a plurality of conductive electrodes on a side of the second substrate away from the first substrate;
providing a third substrate;
forming a first antenna layer including a plurality of first radiators on one side of the third substrate; and
aligning and bonding the second substrate and the third substrate such that the first antenna layer is located on the side of the third substrate facing the conductive layer, and the first projection of the first radiator on the first substrate and the second projection of the conductive electrode on the first substrate are at least partially overlapped and a first liquid crystal layer is formed between the second substrate and the third substrate.

19. The method according to claim 18, wherein forming the phased array antenna layer between the first substrate and the second substrate and forming the conductive layer on the side of the second substrate facing away from the first substrate comprises:
forming a second phase-shifting electrode layer on one side of the first substrate;
forming a ground electrode layer with a plurality of slits on a first side of the second substrate and forming the conductive layer on a second side of the second substrate; and
aligning the first substrate and the second substrate such that the ground electrode layer is located on the side of the second substrate facing the second phase-shifting electrode layer, and a fourth projection of a slit of the ground electrode layer on the first substrate and a third projection of the second phase-shifting electrode layer on the first substrate are at least partially overlapped and a second liquid crystal layer is formed between the first substrate and the second substrate.

20. The method according to claim 19, wherein:
the first substrate includes a first flexible film substrate, providing the first substrate includes providing the first flexible substrate formed on the first substrate, and after forming the first liquid crystal layer between the second substrate and the third substrate, the method further includes peeling off the first flexible substrate from the first substrate; and/or
the third substrate includes a second flexible film substrate, providing the third substrate includes providing the second flexible substrate formed on the second substrate, and after forming the first liquid crystal layer between the second substrate and the third substrate, the method further includes peeling off the second flexible substrate from the second substrate.
